(19) United States
(12) Patent Application Publication
(10) Pub. No.: US 2010/0247784 A1
(43) Pub. Date: Sep. 30, 2010

(54) METHOD OF APPLYING A NON-VOC COATING

(76) Inventor: Richard A Koetzle, Rochester, NY (US)

Correspondence Address: Mark Levy;Hinmann, Howard & Kattel, LLP, 700 Security Mutual Bldg., 80 Exchange Street, Binghamton, NY, 13901, US

(21) Appl. No.: 12/449,792

(22) PCT Filed: Feb. 27, 2007
(86) PCT No.: PCT/US2007/004953

§ 371 Date: Mar. 11, 2010

(51) Int. Cl. B05D 3/02; B08B 3/00

(52) U.S. Cl. 427/386; 427/385.5; 427/387; 134/6; 134/34

(57) ABSTRACT

A method for applying a coating meeting a predetermined volatile organic compound (VOC) standard. The compound functions as a coating and plasticizer. The inventive method involves mixing acetone and terpene alcohol, or terpineol, to form a solvent system with a flash point of at least 140° F. A resin is solubilized into the solvent system and forms a coating. The coating is cast over substrate surfaces to cure and dry. The solvent system produced by the inventive method can also be used in other applications including as a cleaning composition.

### FIELD OF THE INVENTION

The present invention pertains to a method for applying coatings and, more particularly, to a method for applying coatings meeting a predetermined volatile organic compound standard.

### BACKGROUND OF THE INVENTION

In the past several years, concerns have arisen over the use of volatile organic compounds (VOCs). VOCs are organic chemical compounds that have vapor pressures high enough under normal conditions to significantly vaporize and enter the atmosphere. A wide range of carbon-based molecules, such as aldehydes, ketones, and hydrocarbons are VOCs.

Some VOCs react with nitrogen oxides in the air in the presence of sunlight to form ozone. Although ozone is beneficial in the upper atmosphere because it absorbs UV, thus protecting humans, plants, and animals from exposure to dangerous solar radiation, it poses a health threat in the lower atmosphere by causing respiratory problems. In addition high concentrations of low level ozone can damage crops and buildings. Many VOCs found around the house, such as paint strippers and wood preservatives, contribute to sick building syndrome because of their high vapor pressure.

Many coatings are produced by solubilizing solid resins into solvents. Historically, the solvents used have been PM acetate, methyl ethyl ketone, xylene, toluene, butanol, VM&P naphtha and other aliphatic solvents, which are VOCs. The formulation produced from solubilization of the resin in the solvent would then be cast on a substrate creating a protective or decorative film on the substrate by the evaporation of the solvent.

Common artificial sources of VOCs include but are not limited to coatings, industrial cleaning and degreasing products, polishes, adhesives, household chemical products, automotive maintenance products, and metal finishing. The United States Environmental Protection Agency (U.S. EPA) forced industry to switch to water-based coatings, due to the solvent VOC issues in relationship to VOC regulations. This resulted in new solid resins for water-based systems, which do not have the quality of film or performance properties that the solvent systems exhibited. Some of the water-based (latex) problems are:

Poor adhesion

Lower gloss

Less durability—will not wear as well as solvent resins

Viscosity problems

Slow drying or curing

The most common resins used in solution coatings are:

Acrylics

Epoxies

Vinyl

Siloxanes

Epoxy/Siloxanes

Polyvinyl Butryl

Phenolics

Cellulose Acetate Butrate

Asphalt

These coatings are used for concrete, metal, can coatings, printing, industrial paints, paper, wires, ductile metal pipes, roadways, etc.

Many coatings are used to protect surfaces and contribute to a decorative finish. Almost all coatings use a plasticizer, which provides shine and gloss, but many plasticizers are potentially toxic to humans. A toxic vapor can be “leached out” of the coating with time. An example of a plasticizer leaching out is the “new car smell.” The odor is the plasticizers emanating from the plastic materials in the car parts.

Certain countries have passed, or are passing, regulations concerning the VOC content of man-made products, including but not limited to coatings. Thus, there exists a need to provide a method for making a coating that meets a predetermined volatile organic compound standard while functioning as a coating and plasticizer.

U.S. Pat. No. 7,163,979 issued on Jan. 16, 2007 to Shuichi Okazaki et al. for WATER BASED INTERCOAT COATING COMPOSITION AND MULTI-LAYER COATING FILM-FORMING METHOD BY USE OF THE SAME. Okazaki et al disclose a water based intercoat coating composition containing a polyester resin comprising, as essential components, an alicyclic polybasic acid and/or an alicyclic polyhydric alcohol, other polybasic acid and other polyhydric alcohol, a crosslinking agent, and a water based urethane resin emulsion.

U.S. Pat. No. 5,425,893 issued on Jun. 20, 1995 to Edwin Stevens for PHOTOREACTIVE PAINT STRIPPING COMPOSITIONS AND METHOD. Stevens discloses photo-reactive substantially non-toxic, non-flammable safe compositions employing primarily biodegradable components such as conjugated terpenes and related polyenes in combination with solubilizing alcohol for use in removing polymeric materials from substrates, in particular, cured paint from hard and/or flexible surfaces. The compositions avoid the use of methylene chloride, phenol, corrosives and caustics, methanol, toluol or acetone. Compositions according to the Stevens patent preferably have flash points above about 49° C. (about 120° F.), and a pH which is preferably less than about 9. Methods of stripping polymeric coatings from surfaces and methods of making these compositions are also described.

U.S. Pat. No. 7,166,248 was issued on Jan. 23, 2007 to Gary A. Francis et al. for REDUCED VOC EMISSION ALKENYL AROMATIC POLYMER FOAMS AND PROCESSES. Francis et al. disclose a method for producing an alkenyl aromatic polymer foam structure that comprises melting at least one alkenyl aromatic polymer resin. An effective amount of blowing agent mixture is dissolved in the alkenyl aromatic polymer. The blowing agent mixture comprises a VOC blowing agent and acetone. The majority by mole percent of the VOC blowing agent is selected from n-butane, iso-butane, propane and combinations thereof. An extrudate is formed comprising the alkenyl aromatic polymer resin, the VOC blowing agent, and acetone. The extrudate comprises less than about 2.7 wt. % of the VOC blowing agent. The extrudate is transferred to an expansion zone and permitted to expand to produce the foam structure. The foam structure has an extruded density less than about 7 lbs/ft³ and a basis weight of less than about 20 grams per 100 in².

U.S. Pat. No. 7,166,664 issued on Jan. 23, 2007 to Nicole Marie Anderson for LIMONENE, PINENE, OR OTHER TERPENES AND THEIR ALCOHOLS, ALDEHYDES AND KETONES, AS POLYMER SOLVENTS FOR CONDUCTING POLYMERS IN AQUEOUS AND NON-AQUEOUS COATING FORMULATIONS AND THEIR USES. Anderson discloses a low-VOC and/or low-toxicity coating formulation, including at least one non-halogenated solvent including terpene(s) or terpenoid(s), and at least one polymer including conducting polymers, electroactive polymers and/or conjugated polymers, wherein the polymers and non-halogenated solvent(s) are in non-aqueous form. In other embodiments, coating formulations, includes about 0.01% wt. to about 99.9% wt. of at least one non-halogenated solvent including a terpene or terpenoid, about 0.01% wt. to about 90% wt. of at least one polymer including conducting polymers, conjugated polymers, and electroactive polymers, and about 0.001% wt to about 90% wt. of at least one surfactant, wherein the polymers, solvents, and surfactants are in non-aqueous form. Also included are aqueous low VOC and/or toxicity coating formulations having at least one non-halogenated solvent including terpene(s) or terpenoid(s), and at least one conjugated, electroactive, or conductive polymer, copolymer, block polymer, and mixtures thereof.

### SUMMARY OF THE INVENTION

In accordance with the present invention, there is provided a method for applying a compound meeting a predetermined volatile organic compound standard. The compound functions as a coating with a plasticizer. The inventive method involves mixing acetone and terpene alcohol with a resin to solubilize the resin into a coating which is then cast over a substrate surface to dry.

The term “terpene alcohol” is understood for purposes of the present invention to encompass compounds of the formulae C₁₀H₁₈O, which are monocyclic, bicyclic, and acyclic alcohols, respectively. Alpha-terpineol is a commercially available terpene alcohol, which can contain alpha terpene, among other terpene hydrocarbons, and exhibits a flash point of between 180° F. and 200° F., depending upon the volatile impurities present.

Acetone is exempt as a VOC under the United States Environmental Protection Agency's 1990 Clean Air Act Amendment. Acetone is extremely flammable with a flash point of −18° C. (0° F.). When terpene alcohol is added to acetone solvent, the flash point of the solvent is raised above 140° F., which brings the solvent into compliance with U.S. EPA regulations.

The compound formed by performing the steps of the inventive method when used as a coating has largely improved finial film properties over other solvents and over water-based products. The terpene alcohol portion of the blend functions as a plasticizer in the resin, which creates films that are higher gloss, tougher, more flexible, and exhibit improved surface wetting and viscosity. The inventive method may include further steps in which other solvents may be used for particular purposes.

It is an object of the invention to provide a method that applies a compound to substrates to function as a coating.

It is another object of the invention to provide a method that applies a compound which serves as an effective plasticizer when cast over substrates.

It is a further object of the invention to provide a method that applies a compound that complies with standard VOC regulations.

### DETAILED DESCRIPTION OF THE INVENTION

The present invention relates to a method for applying a compound meeting a predetermined volatile organic compound standard. Particularly, the method provides for the application of compounds that act as coatings and plasticizers, and are not harmful as VOCs.

In the past, solution resins were supplied commercially in solvents such as PM acetate, methyl ethyl ketone, xylene, toluene, butanol, VM&P naphtha and other aliphatic solvents that are VOC's, which do not meet the current U.S. EPA VOC regulations. The inventive method produces a compound that meets U.S. EPA regulations.

The inventive method involves first adding a terpene alcohol to acetone until the flash point of the solvent is 140° F. or above. The solvent that is produced is then mixed with a solid resin. The resin is solubilized by the solvent, and forms a compound which can be applied to substrates to act as a coating. The compound can be applied to a substrate by spraying, spreading, rubbing, washing, and immersion, meaning the compound may be contained within a tank into which the substrate to be coated is placed. The film dries and cures in 10-15 minutes. The inventive method may be performed using additional solvents chosen for particular solvate purposes.

The inventive method of dissolving resins in a terpene alcohol/acetone solvent results in compounds with largely improved finial film properties over other methods. The terpene alcohol portion of the resulting compound functions as a plasticizer, which creates films that are higher gloss, tougher, more flexible, and which exhibits improved surface wetting and viscosity.

The inventive method produces a compound that can be used as a coating and a plasticizer, and is VOC-safe. The advantages of the inventive method over prior art methods are that:
it produces compounds that are plasticizers. Terpene alcohol acts as a plasticizer (high boiling alcohol) and acetone/terpene alcohol solubilizes most resins;
terpene alcohol slows down the evaporation, offering an improved dry and cure time;
it produces compounds that have a tougher film finish;
it produces compounds that have higher gloss;
it increases wetting of surface to be coated;
it improves viscosity of solubilized resin allowing ease of application;
it improves penetration into substrate;
it provides for faster drying;
it produces compounds that are non-VOC for all applicable regulations;
it produces compounds with a high flash point; and
it improves re-coat, since the solvent bites into first coat.

The term “terpene alcohol” is understood for purposes of the present invention to encompass compounds of the formulae C₁₀H₁₈O, which are monocyclic, bicyclic, and acyclic alcohols, respectively. Terpene alcohols are structurally similar to terpene hydrocarbons except the structure also includes some hydroxyl functionality. They can be primary, secondary, or tertiary alcohol derivatives of monocyclic, bicyclic, or acylic terpenes as well as above. Such tertiary alcohols include terpineol which is usually sold commercially as a mixture of alpha, beta, and gamma isomers. Linalool is also a commercially available tertiary terpene alcohol. Secondary alcohols include borneol, and primary terpene alcohols include geraniol. Terpene alcohols are generally available through commercial sources.

Alpha terpineol is a commercially available terpene alcohol that can contain alpha terpene, among other terpene hydrocarbons, and exhibits a flash point of between 180° F. and 200° F., depending upon the volatile impurities present.

Acetone is an ideal solvent to mix with terpene alcohol because it is exempt as a VOC under the United States Environmental Protection Agency's 1990 Clean Air Act Amendment. When the terpene alcohol is added to the acetone, the flash point of the solvent is raised above 140° F., which brings the solvent into compliance with U.S. EPA regulations.

The inventive composition may comprise forming a mixture having 1 to 25 weight percent terpene alcohol, and 1.0 to 99.0 weight percent of acetone. A typical combination may comprise 1.0 to 99.0 weight percent acetone and 1.0 to 25.0 weight percent of terpene alcohol, and more specifically, alpha terpineol.

The inventive method can be performed “as is” or may include additional steps, including but not limited to blending the resulting formulation with other organic solvents, for various reasons, including for example, to produce an environmentally safer performance compound. In the event the resulting formulation is further mixed with other solvents, it is desirable for the solvents, like the acetone/terpene alcohol, to have a relativity high flash point. Such solvents include but are not limited to compounds from the group: ketones, alcohols, aromatic and aliphatic-hydrocarbons, esters, ethers, and amines. Examples of solvents that may be employed include:

1) polyhydric alcohols with flash point of 232° F. consisting of ethylene glycol, diethylene glycol, 1,3 butandiol with flash point of 249.8° F.;

2) aliphatic hydrocarbons consisting of 140 solvent with flash point of 140° F., naphtha with flash point of 143.6° F.;

3) aromatic hydrocarbons consisting of isopar L with flash point of 147.2° F.;

4) esters consisting of propylene carbonate with flash point of 269.6° F., dibasic ester with flash point of 212° F.;

5) ethers consisting of diethylene glycol monoethyl ether flash point 204.8° F., diethylene glycol dimethyl ether with flash point of 145.4° F., ethylene glycol dibutyl ether with flash point of 185° F.; and

6) amines consisting of n-methylpyrrolidone with flash point of 269° F.

All of the above-named chemical components are commercially available. The following examples illustrate certain aspects of the present invention, but are not intended to limit the full scope of the invention.

### Example 1

### Acrylic Coating

1) Add alpha-terpineol to acetone (first solvent) to form a second solvent having a flash point of at least 140° F.;

2) In the second solvent, dissolve Paraloid B-64, to form a composition comprising 25 parts by weight of Paraloid B-64 and 75 parts by weight of a second solvent.

Paraloid B-64 is produced by Rohm and Haas Company, Philadelphia, Pa. 19106.

Historically, formulations containing Paraloid B-64 acrylic resin have normally been solubilized in Toluene, Xylene and PM acetate. However, formulations containing these solvents do not meet U.S. EPA VOC regulations.

When Paraloid B-64 was mixed with the acetone/alpha terpineol solvent, it exhibited no VOCs, but had superior gloss, tougher film, and better adhesion and did not require the addition of other plasticizers.

### Example 2

### Acrylic/Vinyl/Cellulose Acetate Butyrate General Purpose Clear Topcoat

1) Add alpha-terpineol to acetone (first solvent) to form a second solvent having a flash point of at least 140° F.;

2) In the second solvent, dissolve a mixture of:

Paraloid A-11

Vinyl Copolymer

Cellulose Acetate Butyrate

to form a composition comprising 32.0 parts by weight Paraloid A-11, 65 parts by weight Vinyl Copolymer, 4 parts by weight Cellulose Acetate Butyrate. A second solvent is required for proper solids or viscosity.

The compounds were produced by the following companies:

Paraloid A-11—Rohm and Haas Company, Philadelphia, Pa. 19106

Vinyl Copolymer—Dow Chemical Co.

Cellulose Acetate Butyrate—Eastman Chemical Products

The Acrylic/Vinyl/Cellulose Acetate Butyrate coating formulated via the inventive method exhibited improved film properties over formulations formulated with VOC solvents. A glossy uniform film was exhibited without the use of any plasticizers.

### Example 3

### Polyvinyl Butyral

1) Add alpha-terpineol to acetone (first solvent) to form a second solvent having a flash point of at least 140° F.;

2) In the second solvent, dissolve a mixture of:

Butvar B-76

Durite P-97

to form a composition comprising 56.7 parts by weight second solvent, 3.3 parts by weight Butvar B-76, and 40.0 parts by weight Durite P-97.

The compounds were produced by the following companies:

Butvar B-76—Solutia, St. Louis, Mo. 63166

Durite P-97—Borden Chemical Company

Mixing the polyvinyl butyral/phenolic resin/alpha terpineol blend created an instant solution and formed an outstanding coating, without the use of any other plasticizers. The dried coating exhibited the same properties as a formulation made with toluene, xylene, methyl isobutyl ketone and ethanol. The formulation exhibited a non-VOC coating with equivalent film properties.

### Example 4

### Silicone/Siloxane

1) Add alpha-terpineol to acetone (first solvent) to form a second solvent having a flash point of at least 140° F.;

2) In the second solvent, dissolve Silblock L-ON, to form a composition comprising 95 parts by weight second solvent and 5 parts per weight Silblock L-ON.

Silblock L-ON was produced by Momentive Co., formerly GE Silicones.

Silblock L-ON is an alkylated alkoxy siloxane, solvent soluble siloxane, which when used with the inventive method formed a stable compound exhibiting a penetrating protective coating for concrete. The Silblock formed a distinct surface film, which is important for visual aspects and not obtained with water based formulations.

### Example 5

### Cellulose Acetate Butyrate Coating

1) Add alpha-terpineol to acetone (first solvent) to form a second solvent having a flash point of at least 140° F.;

2) In the second solvent, dissolve a mixture of:

Cellulose Acetate Butyrate

Mineral Spirits

Acetone/Alpha Terpineol Blend

to form a composition comprising 10.0 parts by weight Cellulose Acetate Butyrate, 15.0 parts by weight Mineral Spirits, and 75.0 parts by weight second solvent.

Mixing the above using the inventive method produced a very high gloss film with excellent flexible properties. The film exposed to salt, UV light, and flexing did not exhibit any breakdown of the film properties.

### Example 6

### Vinyl Resins Coating A

1) Add alpha-terpineol to acetone (first solvent) to form a second solvent having a flash point of at least 140° F.;

2) In the second solvent, dissolve Vinyl Chloride 90%/Vinyl Acetate 10%

to form a composition comprising 15.0 parts by weight Vinyl Chloride 90%/Vinyl Acetate and 85.0 parts by weight second solvent.

### Example 7

### Vinyl Resins Coating B

1) Add alpha-terpineol to acetone (first solvent) to form a second solvent having a flash point of at least 140° F.;

2) In the second solvent, dissolve Vinyl Chloride 90%/Vinyl Acetate 10%

to form a composition comprising 25.0 parts by weight Vinyl Chloride 90%/Vinyl Acetate and 75.0 parts by weight second solvent.

### Example 8

### Vinyl Resins Coating C

1) Add alpha-terpineol to acetone (first solvent) to form a second solvent having a flash point of at least 140° F.;

2) In the second solvent, dissolve Vinyl Chloride 90%/Vinyl Acetate 10%/Hydroxyalkyl acrylate 15% to form a composition comprising 20.0 parts by weight Vinyl Chloride 81%/Vinyl Acetate 4%/Hydroxyalkyl acrylate 15% and 80.0 parts by weight second solvent.

The solvents used to solubilize Vinyl Chloride, Vinyl Acetate and Acrylate resin blends historically have been MEK and toluene blends. The toluene and MEK have been required to “wet” the vinyl resin to form a resin soluble solution. When mixed using the inventive composition, the resins immediately solubilized and formed a film, when applied to substrates.

Those skilled in the art will recognize that the solvent system by the inventive composition via the present inventive method may be used to remove grease and other contaminants from various materials, such as steel, aluminum, and other substrates. The compound is applied to a substrate by spraying, spreading, rubbing, washing, or immersion, meaning the solvent system may be contained within a tank into which the material to be cleaned is placed. Heating of the solvent system may not be needed, depending upon the application, but may be useful because of the high flash point. If the solvent system becomes too concentrated with contaminates, then the bath may be disposed of or the contaminates separated from the solvent system by various means, including but not limited to membrane filtration.

Since other modifications and changes varied to fit particular operating requirements and environments will be apparent to those skilled in the art, this invention is not considered limited to the examples chosen for purposes of this disclosure, and covers all changes and modifications which does not constitute departures from the true spirit and scope of this invention.

Having thus described the invention, what is desired to be protected by Letters Patent is presented in the subsequently appended claims.

I claim:

1. A method of applying a compound meeting a predetermined volatile organic compound standard, the steps comprising:
a) providing a first solvent comprising acetone;
b) mixing a terpene alcohol with said first solvent to form a second solvent having a flash point of at least 140° F.;
c) dissolving at least one resin in said second solvent to form a coating, said resin being selected from the group: acrylic, epoxy, vinyl, siloxane, epoxy/siloxane, polyvinyl butryl, phenolic, petroleum derivative, and cellulose acetate butrate; and
d) applying said coating to a substrate.

2. The method of claim 1, the steps further comprising:
e) allowing said coating to cure and dry.

3. The method of claim 1, wherein said terpene alcohol comprises alpha terpineol.

4. A method of applying a compound meeting a predetermined volatile organic compound standard the steps comprising:
a) providing a first solvent comprising acetone;
b) mixing a terpene alcohol with said first solvent and a second solvent to form a third solvent having a flash point of at least 140° F.;
c) dissolving at least one resin in said third solvent to form a coating, said resin being selected from the group: acrylic, epoxy, vinyl, siloxane, epoxy/siloxane, polyvinyl butryl, phenolic, petroleum derivative, and cellulose acetate butrate; and
d) applying said coating to a substrate.

5. The method of claim 4, the steps further comprising:
e) allowing said coating to cure and dry.

6. The method of claim 4, wherein said terpene alcohol comprises alpha terpineol.

7. A method of applying a coating meeting a predetermined volatile organic compound standard the steps comprising:
a) mixing together to form a solvent system:
i) a first organic solvent selected from the group ketones, alcohols, aromatic hydrocarbons, aliphatic hydrocarbons, ethers and esters, wherein said first solvent has a flash point less than 140° F.; and
ii) a second organic solvent comprising a terpene alcohol in an amount which is about 5 to 45 volume percent of the total solvent system, and sufficient to increase the flash point for the solvent system to over 140° F. when tested in accordance with ASTM D-93; and
b) dissolving at least one resin in said solvent system to form a coating, said resin being selected from the group: acrylic, epoxy, vinyl, siloxane, epoxy/siloxane, polyvinyl butryl, phenolic, petroleum derivative, and cellulose acetate butrate; and
c) applying said coating to a substrate.

8. The method of claim 7, the steps further comprising:
d) allowing said coating to cure and dry.

9. The method of claim 7, wherein said second organic solvent comprises at least 5 to 20 volume percent of alpha terpineol.

10. The method of claim 7, wherein said first organic solvent is acetone, wherein said first organic solvent is present at a concentration of about 82 weight percent and said second organic solvent is present at a concentration of about 18 weight percent of the total solvent system, such that said solvent system has a flash point greater than 140° F.

11. A method of applying a coating meeting a predetermined volatile organic compound standard, the steps comprising:
a) mixing together to form a solvent system:
i) a first organic acetone solvent;
ii) a second organic solvent comprising a terpene alcohol in an amount which is about 5 to 45 volume percent of the total solvent system, and is sufficient to increase the flash point for the solvent system to over 140° F. when tested in accordance of ASTM D-93; and
iii) a third organic solvent with a flash point less than about 140° F. which is not a terpene alcohol;
b) dissolving at least one resin in said solvent system to form a coating, said resin being selected from the group: acrylic, epoxy, vinyl, siloxane, epoxy/siloxane, polyvinyl butryl, phenolic, petroleum derivative, and cellulose acetate butrate; and
c) applying said coating to a substrate.

12. The method of claim 11, the steps further comprising:
d) allowing said coating to cure and dry.

13. The method of claim 11 wherein said second solvent comprises alpha terpineol.

14. A method of applying a coating meeting a predetermined volatile organic compound standard, the steps comprising:
a) mixing together to form a solvent system:
i) a first organic acetone solvent at a concentration of from about 42 percent to about 95 weight percent of the total solvent system;
ii) a second organic solvent comprising a terpene alcohol in an amount which is from about 5 to 20 volume percent of the total solvent system, and is sufficient to increase the flash point of the solvent system to over 140° F. when tested in accordance with ASTM D-93; and
iii) a third organic solvent with a flash point less than 140° F. selected from the group consisting of ketones, alcohols, aromatic hydrocarbons, aliphatic hydrocarbons, ethers, and esters;
b) dissolving at least one resin in said solvent system to form a coating, said resin being selected from the group: acrylic, epoxy, vinyl, siloxane, epoxy/siloxane, polyvinyl butryl, phenolic, petroleum derivative, and cellulose acetate butrate; and
c) applying said coating to a substrate.

15. The method of claim 14, the steps further comprising:
d) allowing said coating to cure and dry.

16. The method of claim 14, wherein said second organic solvent comprises alpha terpineol.

17. A method of applying a cleaning composition comprising:
a) mixing together to form a solvent system:
i) 5 to 45 weight percent alpha terpineol, wherein said alpha terpineol is sufficient to increase the flash point of the cleaning composition to at least 140° F.;
ii) 1 to 35 weight percent of a first organic acetone solvent with a flash point less than 140° F., wherein said first organic solvent is acetone; and
iii) 5 to 90 weight percent of a second organic solvent with a flash point greater than 140° F.; and
b) applying said solvent system to a substrate by at least one selected from the group: spraying, spreading, rubbing, washing, and immersion.

18. The method of claim 17 wherein said first solvent comprises an organic material selected from the group: ketones, alcohols, aromatic hydrocarbons, aliphatic hydrocarbons, ethers, and esters with a flash point less than 140° F., and said second organic solvent comprises an organic material selected from the group: ketones, alcohols, aromatic hydrocarbons, ethers, and esters with a flash point greater than 140° F.

19. The method of claim 17 wherein said second organic solvent is an organic material selected from the group of ketones, alcohols, aromatic hydrocarbons, ethers, and esters with a flash point greater than 140° F.

20. The method of claim 17, wherein said cleaning composition exhibits a flash point over 140° F.
